(19) United States
(12) Patent Application Publication
(10) Pub. No.: US 2008/0010982 A1
(43) Pub. Date: Jan. 17, 2008

(54) Control Valve for a Servo Steering System

(76) Inventors: Thomas Ulbricht, Dusslingen (DE); Edwin Breuning, Denkendorf (DE)

Correspondence Address: ROBERT W. BECKER & ASSOCIATES, 707 HIGHWAY 333, SUITE B, TIJERAS, NM, 87059-7507, US

(21) Appl. No.: 11/776,365

(22) Filed: Jul. 11, 2007

(30) Foreign Application Priority Data
Jul. 11, 2006 (DE) 10 2006 032 314.9

(51) Int. Cl. F16D 31/02

(52) U.S. Cl. 60/384

(57) ABSTRACT

A control valves for a servo steering system, having an inlet for supplying a hydraulic liquid at a first pressures and an outlet for discharging the hydraulic liquid into a region having a smaller, second pressure, especially into a pressureless reservoir. The control valve has a guide and a valve slide accommodated in the guide so as to be movable therein along an axis. The valve slide is acted upon on one side by the hydraulic liquid with the first pressure and on the opposite side by a defined supporting force. An opening structure is provided on at least one of the valve slide and guide. A cover corresponding to the opening structure is provided on the other of the guide and valve slide. A movement of the valve slide relative to the guide effects a change of a free passage area of the opening structure that is not closed off by the cover, whereby the hydraulic liquid is able to flow from the inlet, through the free passage area, to the outlet. The opening structure has a defined shape such that the free passage area of the opening structure does not depend linearly on the movement of the valve slide

### BACKGROUND OF THE INVENTION

The present invention relates to a control valve for a servo steering system, and to a servo steering system for a motor vehicle.

DE 10 2004 044 641 A1 describes a servo steering system for a motor vehicle, in which a rotary slide valve is provided with a reactive arrangement for activating a hydraulic servo motor. The reactive arrangement comprises hydraulically acted-on pressure bodies which depending on the degree of pressure applied, bring about increasing rigidity of the steering system or increased moment resistance of the rotary slide valve. For regulating the pressure of the reactive arrangement, it is know to provide an electrically activated servo valve which regulates the volume flow rate and hence the pressure acting on the reactive arrangement. A control valve is connected in parallel to the reactive unit for limiting pressure. In this known control valve, a hydraulically acted-on valve slide has an opening surface which is rectangular in rolling and is moved, from a hydraulic pressure defined by a resilient force, over a corresponding cover of a guide of the valve slide. This releases a cross section for the passage of the hydraulic liquid, so the hydraulic liquid is able to flow off into a pressureless reservoir. The hydraulic pressure on the reactive unit can in this way be limited by the control valve. The cross section is opened very quickly, in this case, for letting out the hydraulic liquid. The geometrical free opening rises linearly as a function of the deflection of the valve slide. Overall, this means that adjustment can be carried out only insufficiently specifically in the regions of relatively high speed, in which a relatively high steering resistance is required. Alternative measures such as a control circuit comprising a pressure-measuring means or a more markedly differentiated activation of the servo valve are expensive and unreliable on account of their complexity.

The object of the invention is to provide a control valve for a servo steering system That allows improved steering characteristics as a function of the vehicle speed.

According to the invention, this object is achieved, by a control valve, for a servo steering system, having an inlet for supply of a hydraulic liquid at a first pressure, and an outlet for discharge of the hydraulic liquid into a region having a smaller, second pressure, especially into a pressureless reservoir, wherein the control valve further comprises a guide; a valve slide accommodated in the guide such that it is movable in the guide along an axis, wherein the valve slide is adapted to be acted upon on a first side by the hydraulic liquid with the first pressure an on a second opposite side by a defined supporting force; an opening structure provided on at least one of the valve slide and the guide; and a cover means that corresponds to the opening structure and is provided on the other of the guide or valve slide, wherein a movement of the valve slide relative to the guide effects a change of a free passage area of the opening structure that is not closed off by the cover means, whereby the hydraulic liquid is able to flow from the inlet, through the free passage area, to the outlet, and wherein the opening structure has a defined shape such that the free passage area of the opening structure does not depend linearly on the movement of the valve slide.

As a result of the fact that the free cross section or passage area of the opening structure does not depend linearly on the deflection of the valve slide, purposeful influencing of the hydraulic pressure applied to the pressure bodies is facilitated over a relatively large range merely on account of the shaping of the opening structure. Overall, a control valve according to the invention can have a greater influence, in a greater pressure range, on the steering characteristics of a servo steering system than is possible by a pressure-limiting control valve according to the prior art.

In a preferred embodiment, the valve slide has a hollow cylindrical portion, the opening structure being in the form of an aperture in a wall of the portion. A control valve of this type can be manufactured easily and cost-effectively. Particularly preferably, the guide has in this case at least two cylindrical portions having differing diameters, the cover being in the form of a stepped edge of the guide. Also preferably, the cover has in this case a control edge, the control edge being oriented substantially perpendicularly to the cross-sectional surface or area of the opening structure. Overall, the control valve can be manufactured easily in this way, having at the same time reliable regulation and effective sealing when completely closed. Alternatively, the control edge can also be oriented at an angle to the cross-sectional area of the opening other than a right angle.

Generally preferably, the supporting force of a control valve according to the invention is brought about by a spring supporting the valve slide against the guide. In conjunction with adjustability of the resilient force, this provides in a simple manner, in particular, a well-defined operating point of the control valve.

A preferred detailed embodiment makes provision for the cover completely to close the opening structure below a minimum pressure. Alternatively, provision may also be made for the opening structure to have a residual opening even in a pressureless state. However, a constant orifice is preferably provided for this purpose in the valve slide, in addition to the opening structure, the constant orifice providing a permanent connection of the inlet and outlet. A constant orifice of this type allows additional precise correction of the hydraulic pressure acting on the pressure body to be provided.

In a further preferred embodiment, the free cross-sectional area of the opening structure rises more markedly than linearly on increasing deflection of the valve slide from a basic position. This allows desired corrections in the response characteristics of the control valve to be provided compared to the prior art, so the control valve provides initially merely a slight drop in pressure but, as the pressure rises, increasingly more marked limitation of the pressure by an increasingly large volume flow rate of the diverted hydraulic liquid.

In an alternative preferred embodiment, the opening structure comprises, for the sake of simple manufacture, a plurality of circular holes arranged offset in the direction of the axis. Circular holes can be formed with high precision using simple means, flow dynamic influences on the opening structure such as, for example, turbulence being readily calculable. Particularly preferably, in this regard, at least two of the offset holes have a differing diameter in order to provide in a simple manner a markedly non-linear characteristic of the geometric opening as a function of the deflection of the valve slide.

The invention also relates to a servo steering system mentioned at the outset for a motor vehicle, the servo steering system comprising, in accordance with the invention, a control valve as defined. This allows the steering characteristics of the servo steering system to be advantageously influenced, using simple means, at various speeds.

### BRIEF DESCRIPTION OF THE DRAWINGS

Further advantages and features of the invention will emerge from the embodiment described hereinafter in conjunction with the accompanying schematic drawings, in which

FIG. 1 is a schematic view of the hydraulic components of a servo steering system comprising a control valve;

FIG. 2 is a sectional view of a first embodiment of a control valve according to the invention;

FIG. 3 is a detailed enlarged view of detail A from FIG. 2;

FIG. 4 is a sectional view of a second embodiment of a control valve according to the invention;

FIG. 5 is a pressure/volume flow rate diagram of a control valve according to the prior art and of a control valve according to the invention;

FIG. 6 shows measurement curves of the servo pressure, dependent on the steering moment, for a steering system comprising a control valve according to the prior art and for a steering system comprising a control valve according to the invention.

### DESCRIPTION OF SPECIFIC EMBODIMENTS

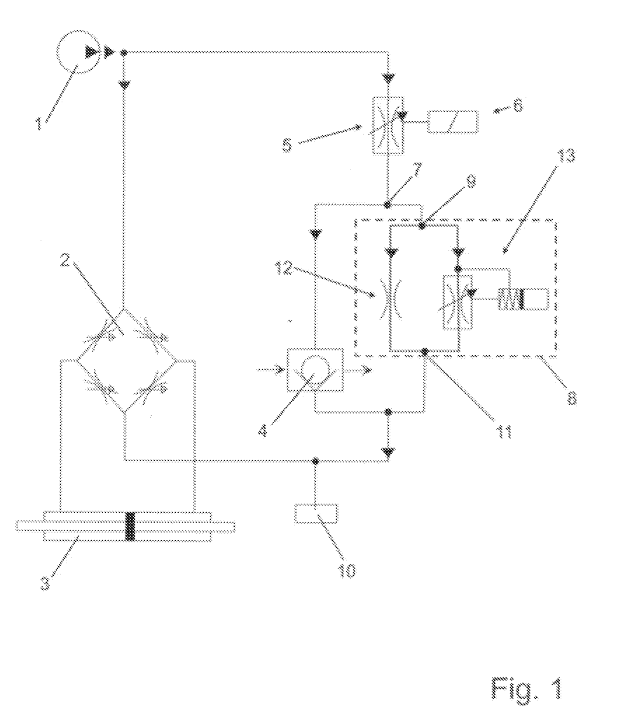

The schematic hydraulic circuit diagram of a servo steering system as shown in FIG. 1 is known. A hydraulic liquid under pressure is supplied, using a pump 1, to a rotary slide valve 2 which is connected to a manually actuated steering wheel of a motor vehicle via a steering column. In the present case, the rotary slide valve has an open center such as is substantially described in DE 10 2004 04 641 A1.

Depending on the torque applied between the steering wheel and a steering gear, the rotary slide valve 2 opens hydraulic lines to a hydraulic servo motor 3. The dependency of this opening or of the pressure differential applied to the servo motor on the torque is referred to, in the present case, as the steering characteristics of the servo steering system. The present servo steering system has steering characteristics which are variable as a function of speed, the rotary slide valve 2 being provided with a reactive arrangement. This reactive arrangement comprises pressure bodies 4 which act on suitably shaped faces of the rotary slide of the rotary slide valve 2 at a differing force, depending on the pressure applied, and thus bring about an adjustably variable rigidity of the steering system.

The pressure bodies 4 are acted on via a servo throttle valve 5 with an adjustable pressure, the full hydraulic pressure of the pump 1 being applied on the input side of the servo throttle valve.

The servo throttle valve 5 is activated via control electronics 6, the electrical control signal of the servo throttle valve depending substantially linearly on the vehicle speed. The throttle valve 5 is thus completely closed at low vehicle speed, for example at parking speed. From a specific, minimum speed or in the fast travel range, the servo throttle valve is completely opened. In speed ranges located therebetween, the servo valve is opened so as to increase linearly with the vehicle speed.

Via a branch 7 provided between the throttle valve 5 and pressure body 4, there is hydraulically connected a control valve 8 which has an inlet 9 and an outlet 11 connected to a pressureless hydraulic reservoir 10.

Two parallel branches are arranged between the inlet 9 and outlet 11, the first branch having a constant orifice 12 and the other having a flow cross section 13 which is variable as a function of pressure.

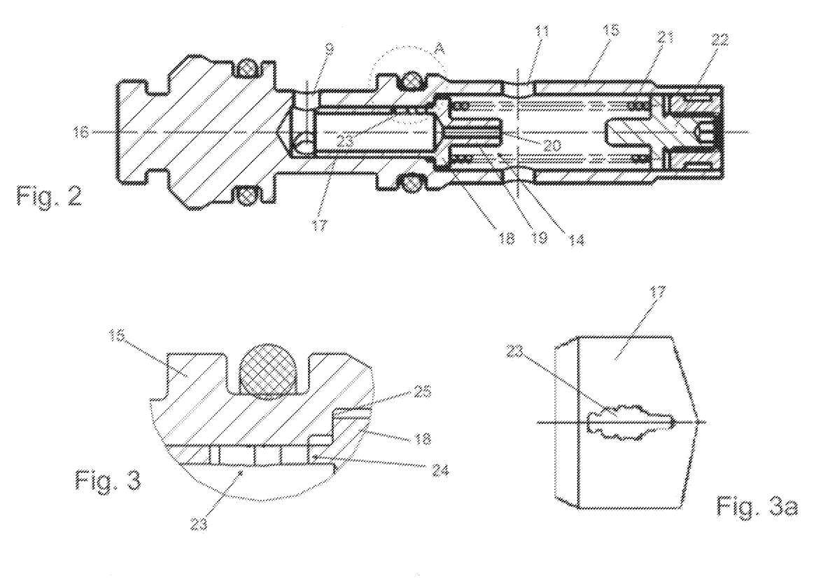

FIG. 2 is a sectional view of a first embodiment of the control valve 8. A valve slide 14 is mounted in a housing-like guide 15 so as to be one-dimensionally displaceable along an axis 16. The valve slide 14 is configured substantially as a hollow cylinder having a cylindrical wall 17. The one base side of the cylindrical wall 17 is open and connected to the inlet 9 of the hydraulic liquid. The other base region of the cylindrical wall 17 is formed by a head part 18 of the valve slide 14 that comprises a hollow cylindrical projection 19 which is rotationally symmetrical to the axis 16. The projection 19 has a central continuous hole 20 which acts as a constant orifice 12 in the control valve. The inlet 9 is permanently connected to an outlet 11 provided in the guide 15, at the other side of the head part 18, via the hole 20, the free cross-sectional surface area of the hole 20 being relatively small and the flow resistance to the hydraulic liquid being relatively high on account of the length of the hole 20.

On the side of the head part 18 that opposes the cylindrical wall 17, the valve slide 14 is supported against the guide 15 via a helical spring 21, the helical spring 21 surrounding the projection 19 which is narrowed in diameter relative to the wall 17. On the side of the guide 15, the helical spring 21 is supported against a bearing block 22 which can be adjustably offset via a thread in order to adjust a biasing of the spring 21. In principle, the resilient force 21 can also be varied, depending on the operating state of the steering system, via electromotive adjustment means.

In the wall 17, an opening structure 23 is provided as an aperture. The inner wall, which guides the valve slide 14 in a sliding and hydraulically tight manner, of the guide 15 forms a cover for the opening structure 23 and ends in a control edge 24. The control edge 24 is located substantially at a right angle to the passage surface of the opening structure 23. A further step 25 of the guide 15 forms a stop for the head part 18, a means for closure, in addition to the control edge 24, between the inlet 9 and outlet 11 being at the same time provided when the head part 18 strikes the step 25.

FIG. 3a shows a rolling of the opening structure 23 of the wall 17 of the valve slide 14. The opening structure 23 is mirror-symmetrical with respect to an axis parallel to the movement of the valve slide 14. The width of the opening structure 23 that is swept by the control edge 24 firstly becomes larger, in the opening direction of the slide, in order then to be substantially constant over a range and finally to become smaller again until the maximum opening is provided by the complete passing of the opening structure 23 over the control edge 24.

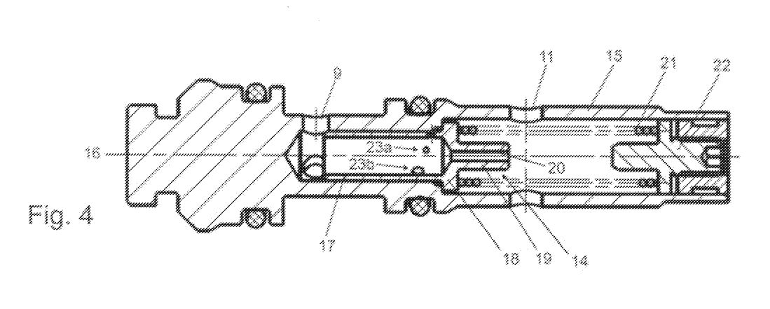

In the second embodiment as shown in FIG. 4, the opening structure comprises two or more circularly round holes 23a, 23b which are each arranged offset relative to one another in the direction of movement of the valve slide 14 and in the circumferential direction of the valve slide 14. The outer edge of the second, larger hole 23b is, in this case, already reached by the control edge 24 completely encircling the valve slide 14 before the first hole 23a is completely swept. With regard to the geometrical free opening cross section for the passage of the hydraulic liquid from the inlet 9 to the outlet 11, the control valve according to the second embodiment behaves in a similar manner to the control valve according to the first embodiment. The formation of the opening structure by a plurality of separate circularly round holes is simplified, in this regard, compared to the opening structure having complex edges from FIG. 3a.

In general, the opening structure can comprise one or more openings which can each be circularly round or else shaped otherwise.

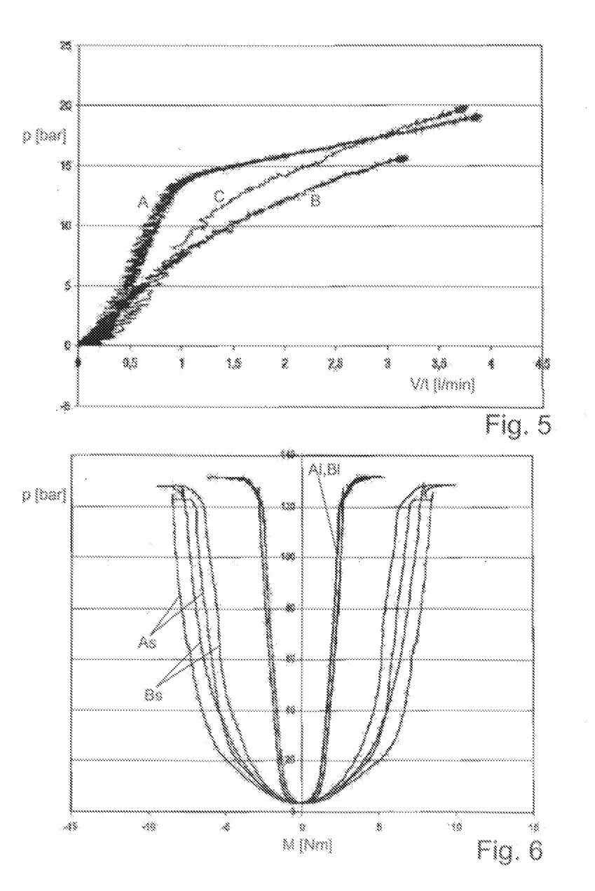

FIG. 5 and FIG. 6 illustrate the principle of the effect of the development according to the invention of the control valve from FIG. 2 to FIG. 4.

In FIG. 5, measurement curve A denotes the control valve characteristic curve according to the prior art. As the pressure rises, the rate of flow from the inlet 9 to the outlet 11 of the control valve according to the prior art increases initially only slowly, this passage being brought about initially exclusively through a constant orifice. Approximately from a pressure of 13 bar, this characteristic curve kinks sharply, and this is caused by the opening of the control valve by the movement of the valve slide. After that, the flow rate rises very steeply compared to the further increase in pressure, so there is a very sharp limitation of the hydraulic pressure acting on the pressure bodies.

The two other measurement curves B and C display the behavior of a control valve according to the invention in the case of a non-linear rise in the free opening cross section. The differing course of the measurement curves B, C derives from differing biasing of the spring 21 of the same control valve.

As may be seen, the measurement curves B, C of the control valve according to the invention have a substantially more uniform course, a higher flow rate tending to be achieved at relatively lower pressures than in the case of the prior art and higher flow rates being achieved at relatively higher pressures than in the prior art, at least in the case of the measurement curve C in pressure ranges above approximately 17 bar.

In FIG. 6, the resultant steering characteristics on use of a control valve according to the invention in a servo steering system as shown in FIG. 1 is compared with the prior art. The pressure differential, applied to the servo motor 3, of the hydraulic liquid is plotted relative to the torque applied to the steering wheel. The curves plotted are genuine measurement curves having a type of hysteresis (double branches of the same measurement for rotating back and forth of the steering wheel). This is a result of the friction in the valves and lines as a result of which differing pressure curves are obtained, depending on the rotational direction of the steering system, as a function of the torque. A slow travel characteristic curve according to the prior art AL and comprising a control valve BL according to the invention and also a fast travel characteristic curve according to the prior art AS and a fast travel characteristic curve comprising the control valve BS according to the invention are plotted in each case. The slow travel curves AL, BL coincide identically within the limits of experimental accuracy. This is to be expected as, in this case, the throttle valve is completely closed and no pressure is applied to the control valve and to the pressure bodies 4. In the respective fast travel characteristic curve according to the prior art AS and comprising the control valve BS according to the invention, on the other hand, there may be seen the influence of the control valve according to the invention, the servo valve and the activation thereof being identical in each case. The characteristic curve BS extends, in particular in the range of relatively high torques, more steeply than the characteristic curve As, so the steering force is assisted somewhat more than in the case of the prior art. Obviously, depending on the configuration of the spring biasing force and the geometry of the opening structure 23, other changes to the steering characteristics can also be undertaken.

An adjustment of the steering characteristics has thus been achieved in a simple and reliable, purely mechanical manner without, for example, the activation of the throttle valve having to be changed.

The specification incorporates by reference the disclosure of German priority document 10 2006 032 314.9 filed Jul. 11, 2006,

The present invention is, of course, in no way restricted to the specific disclosure of the specification and drawings, but also encompasses any modifications within the scope of the appended claims.

We claim:

1. A control valve, for a servo steering system, having an inlet (9) for supply of a hydraulic liquid at a first pressure and an outlet (11) for discharge of the hydraulic liquid into a region having a smaller second pressure said control valve further comprising:
a guide (15);
a valve slide (14) accommodated in said guide (15) such that it is movable in said guide (15) along an axis (16), wherein said valve slide (14) is adapted to be acted upon on a first side by the hydraulic liquid with the first pressure and on a second opposite side by a defined supporting forces;
an opening structure (23) provided on at least one of said valve slide (14) and said guide (15); and
a cover means (15, 24) that corresponds to said opening structure (23) and is provided on the other of said guide (15) and said valve slide (14) wherein a movement of said valve slide (14) relative to said guide (15) effects a change of a free passage area of said opening structure (23) that is not closed off by said cover means (15, 24) whereby the hydraulic liquid is able to flow from said inlet (9), through said free passage area, to said outlet (11), and wherein said opening structure (23) has a defined shape such that said free passage area of said opening structure (23) does not depend linearly on the movement of said valve slide (14).

2. A control valve according to claim 1, wherein said valve slide (14) is provided with a hollow cylindrical portion (17), and wherein said opening structure (23) is embodied as at least one aperture in a wall of said hollow cylindrical portion (17).

3. A control valve according to claim 2, wherein said guide (15) is provided with at least two cylindrical portions having different inner diameters, and wherein said cover means includes a stepped edge (24) of said guide (15).

4. A control valve according to claim 1, wherein a spring (21) is provided that supports said valve slide (14) against said guide (15), and wherein said supporting force is effected by said spring (21).

5. A control valve according to claim 1 wherein said cover means (15, 24) is adapted to completely close off said opening structure (23) below a defined minimum pressure.

6. A control valve according to claim 1 wherein a constant orifice (20) is provided in said valve slide (14) in addition to said opening structure (23), and wherein said constant orifice (20) provides a permanent connection between said inlet (9) and said outlet (11).

7. A control valve according to claim 1, wherein said free passage area of said opening structure (23) is adapted to rise more markedly than linearly as displacement of said valve slide (14) from a basic position increases.

8. A control valve according to claim 1, wherein said opening structure (23) is provided with a plurality of circular holes (23a, 23b) that are offset from one another in the direction of said axis (16).

9. A control valve according to claim 8, wherein at least two of said offset holes (23a, 23b) have a different diameter.

10. A control valve according to claim 1 wherein said cover means is provided with a control edge (24) that is oriented substantially perpendicular to said free passage area of said opening structure (23).

11. A servo steering system for a motor vehicle, comprising,
a rotary slide valve (2) for a torque-dependent activation of a hydraulic servo motor (3);
a reactive means having at least one pressure body (4), wherein a torque dependency of said rotary slide valve (2) is adapted to be adjustably variable by a control pressure exerted on said at least one pressure body (4);
a servo valve (5) adapted to at least partially adjust the control pressure as a function of a speed of the motor vehicle; and
means (8) for limiting a maximum control pressure, wherein said means (8) for limiting a maximum control pressure comprises the control valve of claim 1.
